(19) United States
(12) Patent Application Publication
(10) Pub. No.: US 2008/0012504 A1
(43) Pub. Date: Jan. 17, 2008

(54) Arc lamp circuit

(76) Inventors: Matthew Beasley, Corvallis, OR (US); P Guy Howard, Junction City, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/486,687

(22) Filed: Jul. 14, 2006

(51) Int. Cl. H05B 41/16

(52) U.S. Cl. 315/274

(57) ABSTRACT

Embodiments of a circuit to power an arc lamp are disclosed.

### BACKGROUND

Managing waste heat in systems can contribute to increased size, cost and complexity. Moreover, managing waste heat using a fan can produce undesirable audible noise. Furthermore, waste heat can accelerate degradation of components.

### BRIEF DESCRIPTION OF THE DRAWINGS

The embodiments of an illumination system are better understood with reference to the following drawings. The elements of the drawings may not be to scale relative to each other. Rather, emphasis has instead been placed upon clearly illustrating embodiments of an illumination system. Furthermore, like reference numerals designate corresponding similar parts through the several views.

FIG. 1a and FIG. 1b show an electrical schematic diagram of an embodiment of a direct current arc lamp power supply according to an exemplary embodiment of an illumination system.

FIG. 2a, FIG. 2b, and FIG. 2c show graphs of the voltage as a function of time for an embodiment of a direct current arc lamp system according to an exemplary embodiment of an illumination system.

FIG. 3 and FIG. 4 show exemplary process flow diagrams with sets of procedural acts for controlling an embodiment of a direct current arc lamp according to exemplary embodiments of an illumination system.

### DESCRIPTION

In one embodiment, illumination systems may be used in projectors where information is presented to audiences. The presented information may take the form of a video, a display of a computer program, a slide show, or other types of presentations.

In other embodiments, illumination systems may be used in analytical equipment such as microscopes, spectrometers, or solar simulators.

In yet other embodiments, illumination systems may be used in commercial equipment for theater lighting, surgical illumination, or reprography.

Where precision light control, high power efficiency, or both is desired, an embodiment of a direct current arc lamp may be used.

A direct current arc lamp is powered with at least a substantially constant direct current voltage during operation, and hence stable illumination intensity. Stable illumination results in greater lighting and image control. Therefore, a direct current arc lamp can be used in illumination systems when greater lighting and image control is desired. Direct current arc lamps may be filled with mercury, xenon or other types of gases.

A direct current arc lamp and the circuitry to drive the direct current arc lamp account for a predominant amount of the power used in an illumination system. Furthermore, a significant amount of this consumed power is not converted to light, but rather heat. The illumination system includes the capability to dissipate this undesirable heat. A cooling fan may be used to remove the heat; however, the cooling fan also uses power, is not completely efficient, and thus generates additional heat in an illumination system. Therefore the illumination system would also have to be designed to have the capability to remove this additional heat. Moreover, a cooling fan generates acoustical noise possibly causing the product to be less desirable.

Achieving greater power efficiency reduces the amount of waste heat and thus reduces thermal design constraints on an illumination system. Reducing thermal design constraints on illumination systems allows greater product flexibility. Greater product flexibility allows greater consumer and user acceptance. Thus, it is desirable to achieve greater power efficiency of direct current arc lamp illumination systems to enable greater product acceptance.

Embodiments which achieve greater power efficiency of direct current arc lamp illumination systems are described in reference to the following figures.

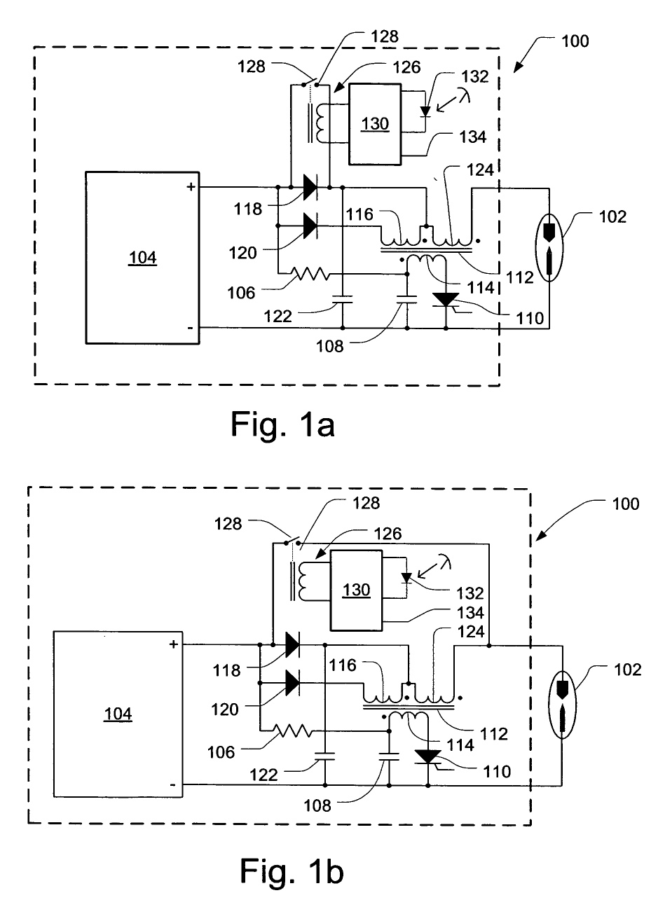

FIG. 1 a illustrates various components of an exemplary embodiment of an illumination system circuit 100. A direct current arc lamp 102 derives power from a direct current power supply 104. If the direct current arc lamp 102 is a mercury arc lamp, the direct current power supply 104 may have a voltage of about 300 volts. If the direct current arc lamp 102 is a xenon arc lamp, the direct current power supply 104 may have a voltage of about 20 volts. These voltages correspond to the steady-state running voltages of the direct current arc lamp 102.

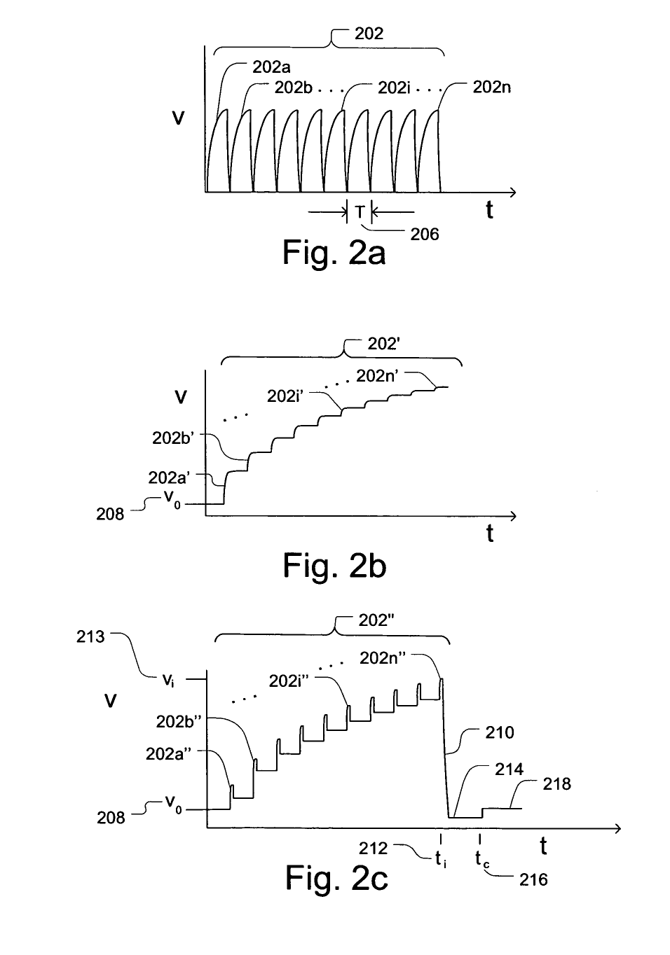

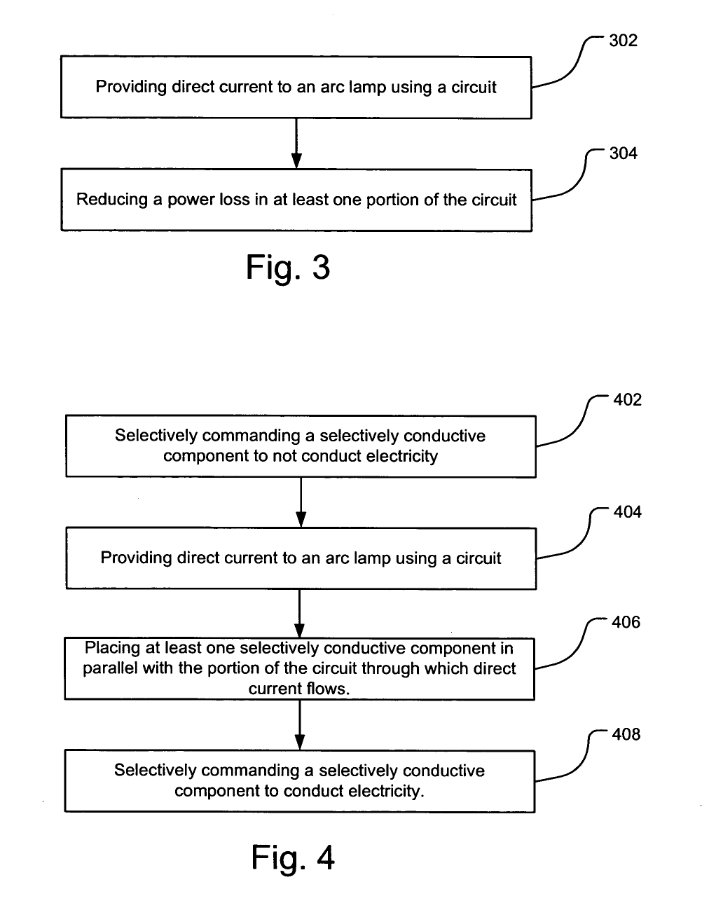

However, to start the direct current arc lamp 102, a voltage of about 3 to 6 kilovolts is used to strike a mercury arc and about 20 kilovolts is used to strike a xenon arc. The process of starting a direct current arc lamp 102 by striking an arc is explained in reference to FIG. 1, FIG. 2, and FIG. 3.

FIG. 1a shows an illumination system circuit according to one embodiment of an illumination system. A resistor 106, a first capacitor 108, a thyristor 110, and a transformer 112 form a relaxation oscillator. The first capacitor 108 is charged by the direct current power supply 104 through a resistor 106 such that the voltage on the first capacitor 108 exceeds a turn on voltage of the thyristor 110. If the turn on threshold voltage is exceeded, the thyristor conducts current from the first capacitor 108 through the primary winding 114 of transformer 112 thereby discharging and reducing the voltage across the first capacitor 108. Upon discharging the first capacitor 108, the first capacitor 108 is again charged by the direct current power supply 104 through the resistor 106. Once again, the voltage on the first capacitor 108 exceeds the turn on threshold voltage of the thyristor 110, and the thyristor 110 discharges the first capacitor 108 through the primary winding 114 of transformer 112. This cycle of charging the first capacitor by the resistor 106 and discharging the first capacitor by the thyristor 110 continues as shown by a voltage time graph in FIG. 2a with an oscillation period 206 of approximately 0.2 to 10 milliseconds.

In FIG. 2a, this charging and discharging process produces a voltage pulse train 202 including an initial pulse 202a, a subsequent pulse 202b, and other pulses, such as pulses 202i and 202n.

The voltage pulse train 202 causes pulses of current to flow through the primary winding 114 of the transformer 112. These pulses of current are transformed by the first secondary winding 116 of transformer 112 into a voltage pulse train 202′ as shown in FIG. 2b. The voltage pulse train 202′ is directed by a first diode 118 and a second diode 120 such that the polarity of the pulse train 202′ voltage adds to the voltage of the direct current power supply 104. The pulse train 202′ voltage is accumulated by a second capacitor 122 such that the accumulated voltage of the pulse train 202′ increases with time as shown by FIG. 2b. Within the pulse train 202′, individual pulses 202a′, 202b′, 202i′, 202n′ are shown, each pulse increasing in voltage with time.

While the pulse train 202′ voltage is accumulating on the second capacitor 122, a second secondary winding 124 on the transformer 112 creates a high voltage as shown in FIG. 2c from the current flowing in the primary winding 114 of the transformer 112. The high voltage is added to the second capacitor 122 voltage, thereby creating an even higher pulse train 202″ voltage. When the voltage of the pulse train 202″ is presented to the direct current arc lamp 102, the voltage builds over time and becomes high enough to spark the direct current arc lamp 102. When the direct current arc lamp 102 sparks, a portion of the gas between the electrodes ionizes. The ionization creates a low impedance path across the lamp electrodes whereby the voltage in the second capacitor 122 flows to the direct current arc lamp 102, thereby forming a plasma. The plasma around the electrodes of the arc lamp further lowers the impedance across the electrodes of the direct current arc lamp. This process is often termed “striking the arc.” Both the spark and plasma events occur very rapidly, resulting in a decaying voltage 210 across the direct current arc lamp 102 as shown in FIG. 2c.

“Striking the arc” results in sufficiently low impedance across the direct current arc lamp 102 such that the direct current arc lamp 102 can be powered by current flowing from the direct current power supply 104 through the first diode 118 and the second secondary winding 124 of the transformer 112. When this condition is established, the direct current arc lamp 102 is said to be “running”, in the “run mode”, or in the “run state.”

When the direct current arc lamp 102 is in the “run state”, the initial voltage 208 as shown in FIG. 2c of the direct current power supply 104 drops to a loaded circuit voltage 214 which is lower than the initial voltage 208. This loaded circuit voltage 214 results from the load of the direct current arc lamp 102 on the direct current power supply 104. When the voltage of the direct current power supply 104 drops, the relaxation oscillation ceases, since the loaded circuit voltage 214 on the direct current power supply is lower and thus insufficient to charge the first capacitor 108 to a voltage level that exceeds the thyristor 110 breakdown voltage. As a result, the oscillation ceases and direct current flowing through second secondary winding 124 of transformer 112 causes the transformer 112 to saturate. Saturation of transformer 112 provides a path of direct current from the direct current power supply 104 through both the first diode 118 and the second secondary winding 124 of the transformer 112.

For a 400 watt xenon direct current arc lamp, the direct current power supply 104 provides a voltage of about 20 volts with a current of about 20 amperes. The approximately 20 amperes of current from the direct current power supply 104 flowing through the first diode 118 to the direct current arc lamp 102 causes about one volt to drop across the first diode 118. The one volt dropped across the first diode 118 with 20 amperes flowing through the first diode 118 results in about 20 watts of power dissipated as heat and thus lost in the first diode 118. This 20 watt power loss in the first diode 118 contributes to loss of power efficiency in a direct current arc lamp illumination system circuit 100.

One way to interpret the power lost in the first diode 118 (about 20 watts) is to compare it to the power lost in the illumination system circuit 100. The illumination system circuit 100 may be referred to as the ballast. As an example, the illumination system circuit 100 consumes about 60 watts of power. The power loss in the first diode 118 is about 20 watts. Comparing the power loss in the first diode 118 (about 20 watts) with the total power consumed in the illumination system (about 60 watts) results in about 33% of the power consumed in the first diode 118 relative to the total ballast power. As a result, reducing the power consumed in the first diode 118 may reduce the degree of cooling for the ballast by about 33%. Since the ballast includes heat sensitive components for which greater reliability may be achieved with cooling, this reduced level of cooling may significantly relax thermal design constraints for products thereby enabling new product applications such as portability, reduction of noise due to reduced cooling, and the like. Another way to interpret the power lost due to the first diode 118 is to compare the power lost in the first diode 118 (about 20 watts) to the total power consumed in a projector. As an example, using a 400 watt xenon direct current arc lamp 102, a projector consumes about 460 watts. 400 watts (20 amperes*20 volts) is consumed by the direct current arc lamp 102 plus about 60 watts is consumed by the illumination system circuit 100. Therefore, the calculated power loss is found by dividing the power lost in the first diode 118 by the consumed power (about 460 watts) resulting in 20/460 or about 4% of the total power. From a thermal design constraint point of view, some of the consumed power will be projected out of the projector as optical power and may result in a higher fraction of power lost in the first diode 118 as compared to the amount of power associated with heat.

In any case, the power lost in the first diode 118 is significant, and for the reasons already mentioned above, it is desirable to reduce this power loss.

To reduce power loss in the first diode 118, it is advantageous to have a low forward voltage drop. However, the first diode 118 also serves to block the reverse flow of current at high voltages when charging the second capacitor 122. These goals tend to be mutually exclusive. Consequently, it is impractical to design a diode that simultaneously meets a high reverse breakdown voltage while providing a low forward voltage drop for the illumination system circuit 100. Therefore, power loss across the first diode 118 is a concern.

If the direct current arc lamp 102 has already been started by the illumination system circuit 100, for instance, if the direct current arc lamp 102 is in the “run mode”, then the power loss across the first diode 118 may be reduced by placing contacts 128 of a selectively conductive component 126 in parallel with the first diode 118. As an example in FIG. 1a and FIG. 1b, the selectively conductive component 126 may be a relay. However, the selectively conductive component 126 may be a component other than a relay. The selectively conductive component may be one or more of a bipolarjunction transistor, a junction field effect transistor, a MOS field effect transistor, a silicon controlled rectifier, a triac, a diac, a varistor, or another type of device.

In FIG. 1a, if the contacts 128 of the selectively conductive component 126 are closed, then the voltage across the first diode 118 is reduced. This reduced voltage results in a reduced power loss in the first diode 118. The contacts 128 of the selectively conductive component 126 provide a path in the illumination system circuit 100 for the direct current to flow. The reduced voltage across the parallel combination of the first diode 118 and the contacts 128 provides a greater voltage to the direct current arc lamp 102 thereby increasing illumination system efficiencies.

Moreover, if the contacts 128 are closed, the resistance of the parallel combination of the first diode 118 with the contacts 128 of the selectively conductive component 126 may significantly lower the resistance of the circuit through which the direct current flows, in this case the first diode 118. Because the combined parallel resistance is less, the power loss in the illumination system circuit 100 through which the direct current flows is less, and greater illumination system circuit efficiency results. Also, since the parallel combination of the first diode 118 and the contacts 128 result in a lower resistance, a greater voltage can be provided to the direct current arc lamp 102 thereby increasing illumination system efficiencies.

The contacts 128 of the selectively conductive component 126 may be selectively commanded to open or close. For example, the contacts 128 may be opened to provide for “striking the arc” of the direct current arc lamp 102, or the contacts 128 may be closed while the direct current arc lamp 102 is “running.” The selective signal and/or command which opens and/or closes the contacts 128 of the selectively conductive component 126 may thereby provide a selectively changing path of direct current from the direct current power supply 104 to the direct current arc lamp 102 in the illumination system circuit 100. When “striking the arc” the path of the power may flow through a first path such as the first diode 118. After “striking the arc” where the direct current arc lamp is in the “run mode”, the path of the power may be selectively commanded to flow through a second path such as through the contacts 128 of the selectively conductive component 126 in parallel with the first diode 118.

Various components may be used to provide alternate paths of current or power in order to bypass the direct current flowing through the first diode 118. Examples of a selectively conductive component 126 include, but are not limited to, a bipolar junction transistor, a junction field effect transistor, a MOS field effect transistor, a silicon controlled rectifier, a triac, a diac, a varistor, or similar types of devices. Also, alternate forms of bypassing the first diode 118 may include the use of combinations of switching devices. For example, the selectively conductive component 126 may be combined with other selectively conductive components 126. The combination of selectively conductive components 126 may serve to bypass the first diode 118. Furthermore, other alternate forms of bypassing the first diode 118 may be combined with each other.

In FIG. 1b, the second secondary winding 124 of the transformer 112 has resistance. If current flows through the second secondary winding 124, power is lost. If the direct current arc lamp 102 is in the “run mode”, the selectively conductive component 126 may also be used to shunt current and/or power around both the second secondary winding 124 and the first diode 118 as shown in FIG. 1b. Therefore, the current and/or power flows through selectively conductive component 126 and bypasses the lossy first diode 118. The selectively conductive component 126 may also be used to bypass the current and/or power around the second secondary winding 124 without bypassing the current and/or power around the first diode 118. Although power loss can be reduced by bypassing both of these components, care should be taken to increase the likelihood that the selective conductive component 126 can withstand the striking voltage of the illumination system circuit 100.

The contacts 128 of the selectively conductive component 126 may be selectively commanded to be opened or closed by a circuit 130. The selective command from circuit 130 can occur after a certain amount of time has elapsed. Also selectively conductive component 126 may be activated by the circuit 130 based on an event. Furthermore, the contacts 128 of selectively conductive component 126 may be closed or opened by the circuit 130 based on combinations of time and events.

Several examples of events are listed below. For example, an event may be the drop in the initial voltage 208 of the direct current power supply 104 as shown in FIG. 2c which is indicative that the direct current arc lamp 102 is in the “run mode” and thereby presenting a loaded circuit voltage 214 to the direct current power supply 104. An event may also be the relatively high amount of current flowing to the direct current arc lamp through the first diode 118. An event may be relatively high amounts of current flowing through the second secondary winding 124 of transformer 112. An event may also be the amount of power to the direct current arc lamp 102. An event may also be the light produced from the direct current arc lamp 102 and detected by a photodetector 132. In addition to these events, an event may also be any combination of the individual events. Other events may be input to circuit 130 on input line 134. Furthermore, there may be other inputs lines in addition to input line 134. Events may be detected using voltage, current, light, and power sensors.

Examples of current sensors are magnetic Hall Effect sensors, magnetic saturation sensors, detection of the voltage drop across an impedance sensor, and the like. Voltage sensors may include an amplifier followed by a threshold detector such as a comparator. Light may be detected with one or more photodetectors using a transconductance amplifier and a comparator. A power sensor may use a voltage sensor and a current sensor together. Power sensors may measure heat dissipated in a component of the illumination system circuit 100 or the direct current arc lamp 102 or both.

To better understand the operation of an embodiment of an illumination system, FIG. 2 shows timing diagrams of an embodiment of an illumination system as shown in FIG. 1. FIG. 2a shows a voltage pulse train 202 from the illumination system circuit including individual pulses 202a, 202b . . . and 202n. The voltage pulse train 202 is formed by oscillations from the circuit, the circuit including a direct current power supply 104, a resistor 106, a first capacitor 108, a thyristor 110 and a primary winding 114 of a transformer 112.

The first capacitor 108 is charged by the direct current power supply 104 and the resistor 106 thereby generating the rising shape of the pulse 202a. The first capacitor 108 is discharged by the thyristor 110 to create the falling edge of the pulse 202a.

The oscillation period 206 of the voltage pulse train is dependent upon the selection of the resistor 106, the first capacitor 108, the direct current power supply 104 voltage, the second secondary winding 124 of the transformer 112, and the thyristor 110 threshold voltage. An oscillation period 206 may be between 0.2 to 10 milliseconds.

FIG. 2b shows an initial voltage 208 across capacitor 122 and a voltage pulse train 202′. The voltage of pulse train 202′ is the voltage of pulse train 202 of FIG. 2a accumulated on the second capacitor 122 of FIG. 1. The accumulated voltage on the second capacitor 122 starts at an initial voltage 208. The initial voltage 208 on the second capacitor 122 is the voltage of the direct current power supply 104 minus the voltage drop across the first diode 118 in FIG. 1. The pulse train 202 voltage in FIG. 2a is increased by the first secondary winding 116 of transformer 112. This increased voltage is directed by the first diode 118 and the second diode 120 to add to the second capacitor 122 voltage. The second capacitor 122 accumulates the increased pulse train 202′ voltage as illustrated in FIG. 2b.

FIG. 2c shows an initial voltage 208 across the direct current arc lamp 102, a voltage pulse train 202″, a decaying voltage 210, a loaded circuit voltage 214 which is lower than the initial voltage 208, and a reduced power loss voltage 218. The voltage of the pulse train 202″ starts at an initial voltage 208. In FIG. 2b, the initial voltage 208 is the voltage of the direct current power supply 104 less the voltage drop across the first diode 118. The initial voltage 208 is applied to the direct current arc lamp 102 by second secondary 124 of transformer 112. The second secondary winding 124 increases the voltage of the pulse train 202 in FIG. 2a and furthermore adds this increased voltage to the already accumulated voltage on the second capacitor 122. A resulting pulse train 202″ of high voltage results. The direct current arc lamp 102 is presented with the pulse train 202″ voltage. When the voltage of the pulse train 202″ is sufficiently high, the direct current arc lamp 102 ionizes and starts to conduct current. For mercury direct current arc lamps, the threshold voltage for conduction is about 3 kilovolts to 6 kilovolts. For xenon direct current arc lamps, the threshold voltage for conduction is about 20 kilovolts.

Due to the ionization conduction of the direct current arc lamp 102, the voltage of the pulse train 202″ undergoes a decaying voltage 210 at an ionization time 212 when an ionization voltage 213 is exceeded. Moreover, the stored energy in second capacitor 122 releases energy through the second secondary winding 124 of the transformer 112 sustaining the ionization conduction and forming a plasma. The plasma is sufficient to establish conduction in the direct current arc lamp 102 such that the direct current power supply 104 voltage maintains energy to the direct current arc lamp 102. The arc lamp is now “running.” The voltage presented to the direct current arc lamp 102 in this “run mode” is the loaded circuit voltage 214. The loaded circuit voltage 214 is the voltage of the direct current power supply 104 minus the voltage drop across the first diode 118 and the voltage drop across the second secondary winding 124 of the transformer 112. The loaded circuit voltage 214 presented across the direct current arc lamp 102 in this “run mode” is less than the initial voltage 208 of the direct current power supply 104. If thyristor 110 is sized to have a threshold breakdown voltage less than the loaded circuit voltage 214 of the direct current power supply 104, then the relaxation oscillations formed by the resistor 106, the first capacitor 108, the thyristor 110, the first primary winding 114, and the direct current power supply 104 no longer occurs.

When the arc lamp is in the “run mode”, the achievable power efficiency of an illumination system circuit can be increased by adding a selectively conductive component 126, for example a relay across the first diode 118. At a time of conduction 216, the selectively conductive component 126 is commanded to conduct electricity, and the voltage presented to the direct current arc lamp 102 increases to establish a reduced power loss voltage 218. The reduced power loss voltage 218 is higher than the loaded circuit voltage 214 because the voltage drop across the first diode 118 is reduced. This reduction in voltage across the otherwise lossy first diode 118 reduces the power loss of the illumination system circuit 100.

The selectively conductive component 126 can be commanded and/or signaled by a circuit 130. The circuit 130 can be commanded and/or signaled by events. An example of an event is an illumination from a photodetector 132 or other commands and/or signaling events in the illumination system circuit 100 which can be input to circuit 130 through input 134. Other examples of events are voltage events, current events, power events, and the like. There may be one or more inputs in addition to 30 input 134 where detected events can command and/or signal circuit 130. The circuit 130 may include analog to digital converters, microcontrollers, microprocessors, amplifiers, latches, logic devices, filters and/or other components to process and condition the events.

If the direct current power supply 104 voltage is removed from the illumination system circuit 100, for example, when the illumination device is turned off, the illumination system circuit 100 can restart the illumination process. The process can start with relaxation oscillations to strike the arc. After the arc has been established and running, the illumination system circuit 100 can command alternate paths of power through at least one portion of the illumination system circuit 100. The illumination system circuit 100 may direct current flow, for example by using a selectively conductive component 126 to reduce power loss in at least one portion of the illumination system. The selectively conductive component 126 may be a relay, a thermal switch, a mechanical switch, a bipolar junction transistor, a thyristor, a field effect transistor, a varistor, and the like. The power loss in at least one portion of the illumination system may be the first diode 118, the second secondary winding 124 of the transformer 112 or combinations thereof.

FIG. 3 shows an exemplary flow diagram with procedural acts for controlling a direct current arc lamp 102 using an illumination system circuit 100. As previously described, the arc is struck and established by a high voltage.

After the arc has been struck, the arc lamp is run by the act of providing direct current to an arc lamp using a circuit, the act shown in 302. The direct current is provided by an illumination system circuit 100.

After the arc has been struck and the arc lamp is running under power from the illumination system circuit 100 by the direct current power supply 104, the act of reducing power loss in at least one portion of the circuit is shown in act 304. The power loss may be reduced by reducing the resistance of at least one component of the illumination system circuit. The power loss may also be reduced by reducing the voltage drop across at least one component of the illumination system circuit.

FIG. 4 shows another exemplary flow diagram with procedural acts for controlling a direct current arc lamp 102 using an illumination system circuit 100.

Selectively commanding a selectively conductive component in an illumination system circuit 100 to not conduct electricity allows the arc to be struck as shown in act 402 and is described in reference to FIG. 1 and FIG. 2.

After the arc has been struck, the act of providing direct current to an arc lamp is provided by an illumination system circuit 100 to run the arc lamp as shown in act 404.

Included in the circuit is a least one selectively conductive component 126 in parallel with the portion of the illumination system circuit 100 through which the direct current flows is shown in act 406. The selectively conductive component may be a bipolar junction transistor, a junction field effect transistor, a MOS field effect transistor, a silicon controlled rectifier, a triac, a diac, a varistor, or another similar type of device.

Power loss in the illumination system circuit 100 may be reduced by selectively commanding the selectively conductive component 126 in the circuit to conduct electricity as shown in act 408. Commanding the selectively conductive component 126 may be accomplished by circuit 130 as described in reference to FIG. 1 and FIG. 2.

While the present embodiments of illumination systems have been drawn to describe and teach the operation of the embodiments, the drawings may not be true to scale. Furthermore, various parts of the active elements have not been drawn to scale. Certain dimensions have been exaggerated in relation to other dimensions in order to provide a clearer illustration and understanding of the present disclosure.

While the present embodiments of illumination systems have been particularly shown and described, those skilled in the art will understand that many variations may be made therein without departing from the spirit and scope of the embodiments defined in the following claims. The description of the embodiment is understood to include all novel and non-obvious combinations of elements described herein, and claims may be presented in this or a later application to any novel and non-obvious combination of these elements. The foregoing embodiments are illustrative, and no single feature or element would have to be included in all possible combinations that may be claimed in this or a later application. Where the claims recite “a” or “a first” element of the equivalent thereof, such claims should be understood to include incorporation of one or more such elements, neither specifically including nor excluding two or more such elements.

What is claimed is:

1. A method, comprising:
providing a direct current to an arc lamp using a circuit; and
reducing a power loss in an at least one portion of the circuit through which the direct current flows.

2. The method of claim 1, wherein reducing the power loss in the at least one portion of the circuit through which the direct current flows further comprises reducing a resistance of the at least one portion of the circuit through which the direct current flows and wherein the arc lamp includes a direct current arc lamp.

3. The method of claim 1, wherein reducing the power loss in the at least one portion of the circuit through which the direct current flows further comprises reducing a voltage across the at least one portion of the circuit through which the direct current flows and wherein the arc lamp includes a direct current arc lamp.

4. The method in claim 1, further comprising:
placing the at least one selectively conductive component in parallel with the at least one portion of the circuit through which the direct current flows; and
selectively commanding the at least one selectively conductive component to, when in a first state, to conduct electricity, and to, when in a second state, to not conduct electricity.

5. The method in claim 4, wherein selectively commanding the at least one selectively conductive component is selectively commanded based on time.

6. The method in claim 4, wherein selectively commanding the at least one selectively conductive component is selectively commanded based on one or more of a voltage event, a current event, a power event, an illumination event, or combinations thereof.

7. An apparatus, comprising:
a first circuit for providing a power to an arc lamp;
an at least one component in the first circuit through which the power to the arc lamp can flow; and
an at least one selectively conductive component in parallel with the at least one component in the first circuit, through which the power to the arc lamp can flow.

8. The apparatus of claim 7, wherein the arc lamp includes a direct current arc lamp.

9. The apparatus of claim 8, wherein the at least one portion of the first circuit includes at least one diode or one transformer or combinations thereof.

10. The apparatus in claim 8 wherein the at least one selectively conductive component includes one or more of a mechanical switch, a relay, a thermal switch, a bipolar junction transistor, a thyristor, a field effect transistor, a varistor, or combinations thereof.

11. The apparatus in claim 8, wherein the at least one selectively conductive component in parallel with the at least one component in the first circuit is selectively connected in parallel to the at least one component in the first circuit by a command from a second circuit.

12. The apparatus in claim 11, wherein the at least one selectively conductive component in parallel with the at least one component in the first circuit is selectively connected in parallel to the at least one component in the first circuit by a command from the second circuit, wherein the second circuit is a timing circuit.

13. The apparatus in claim 11, wherein the at least one selectively conductive component in parallel with the at least one component in the first circuit is selectively connected in parallel to the at least one component in the first circuit by a command from the second circuit, wherein the second circuit is a circuit which detects one or more of a voltage event, a current event, a power event, an illumination event or combinations thereof.

14. A circuit for an arc lamp, comprising:
a means for routing power to the arc lamp through a first path; and
a means for routing power to the arc lamp through a second path.

15. The circuit of claim 14, wherein the means for routing power to the arc lamp through the second path includes a means for reducing the power through the means for routing power to the arc lamp through the first path wherein the arc lamp includes a direct current arc lamp.

16. The circuit of claim 14, wherein the means for routing power to the arc lamp through the second path includes a means for reducing a voltage across the means for routing power to the arc lamp through the first path wherein the arc lamp includes a direct current arc lamp.

17. The circuit of claim 14, wherein the means for routing power to the arc lamp through the second path includes a means for reducing a resistance of the means for routing power to the arc lamp through the first path wherein the arc lamp includes a direct current arc lamp.

18. The circuit of claim 14, wherein the means for routing power to the arc lamp through the second path further comprises a means for selectively conducting current in parallel with the means for routing power to the arc lamp through a first path wherein the arc lamp includes a direct current arc lamp.

19. The circuit of claim 14, wherein the means for selectively conducting current in parallel with the means for routing power to the arc lamp is responsive to one or more of a means for sensing a power event, a voltage event, a current event, an illumination event or combinations thereof wherein the arc lamp includes a direct current arc lamp.

20. The circuit of claim 14, wherein the means for selectively conducting current in parallel with the means for routing power to the arc lamp is responsive to a means for measuring time wherein the arc lamp includes a direct current arc lamp.
